(19) United States
(12) Patent Application Publication
(10) Pub. No.: US 2026/0146899 A1
(43) Pub. Date: May 28, 2026

(54) APPARATUS FOR EARLY DETECTION OF THERMAL OVER EXPOSURE ON ELECTRICAL CONNECTORS

(71) Applicant: FCA US LLC, Auburn Hills, MI (US)

(72) Inventors: Arturo Guzman-Magana, Auburn Hills, MI (US); Mark Doroudian, Auburn Hills, MI (US); Rohitashwa Kiran, Auburn Hills, MI (US)

(21) Appl. No.: 18/961,539

(22) Filed: Nov. 27, 2024

(51) Int. Cl. G01K 5/32; G01K 5/34; H01R 13/46

(52) U.S. Cl. CPC G01K 5/323; G01K 5/34; H01R 13/465; H01R 2201/26

(57) ABSTRACT

An apparatus for early detection of thermal over exposure on a vehicle component is provided. The apparatus includes a sealed capsule, a liquid and an ultraviolet (UV) dye. The liquid is contained in the sealed capsule. The liquid is configured to expand upon reaching a threshold trigger temperature. The UV dye is disposed in the liquid. The liquid is configured to break the sealed capsule upon reaching the threshold trigger temperature, the liquid and UV dye thereby spilling onto the vehicle component allowing subsequent identification using a UV light.

### FIELD

The present application generally relates to an apparatus for early detection of thermal over exposure on vehicle components, such as electrical connectors.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Over time, components of a vehicle might experience over exposure to high temperatures. As a result, such as after several cycles, this might change the characteristics of certain vehicle components. Automotive technicians and thermal engineers struggle to find, diagnose and pin-point electrical problems caused by thermal damages in plastic harnesses and electrical connectors. In particular, some components formed of certain plastics, silicones or other temperature sensitive materials can experience thermal over exposure and damage. As these materials change, they can eventually develop a fault, or a miss read of an electrical signal such as those related to a sensor connector. As thermal damage on electrical connectors is difficult to see, it is often difficult to assess where exactly thermal damage has occurred. Electrical faults are inherently difficult to properly diagnose due to the complexity of the electrical systems and the number of wires on an automotive harness. Accordingly, there exists an opportunity for improvement in the relevant art.

### SUMMARY

In accordance with one example aspect of the invention, an apparatus for early detection of thermal over exposure on a vehicle component is provided. The apparatus includes a sealed capsule, a liquid and an ultraviolet (UV) dye. The liquid is contained in the sealed capsule. The liquid is configured to expand upon reaching a threshold trigger temperature. The UV dye is disposed in the liquid. The liquid is configured to break the sealed capsule upon reaching the threshold trigger temperature, the liquid and UV dye thereby spilling onto the vehicle component allowing subsequent identification using a UV light.

In addition to the foregoing, the sealed capsule comprises glass.

In addition to the foregoing, the sealed capsule comprises an ampule.

In addition to the foregoing, the vehicle component comprises an electrical connector.

In other examples, the electrical connector comprises a connector body having a plurality of electrical connector portions.

In additional implementations, the connector body is formed of plastic.

In additional examples, the liquid is configured to boil at the threshold trigger temperature.

In addition to the foregoing, the liquid is configured to increase pressure on the sealed capsule upon reaching the threshold trigger temperature causing the sealed capsule to fail.

In accordance with another example aspect of the invention, an apparatus for early detection of thermal over exposure on a vehicle component includes an electrical connector, a sealed capsule, a liquid and an ultraviolet (UV) dye. The sealed capsule is disposed on the electrical connector. The liquid is contained in the sealed capsule. The liquid is configured to expand upon reaching a threshold trigger temperature. The UV dye is disposed in the liquid. The liquid is configured to break the sealed capsule upon reaching the threshold trigger temperature, the liquid and UV dye thereby spilling onto the electrical connector allowing subsequent identification using a UV light.

In addition to the foregoing, the sealed capsule comprises glass.

In addition to the foregoing, the sealed capsule comprises an ampule.

In other examples, the electrical connector comprises a connector body having a plurality of electrical connector portions.

In other implementations, the connector body is formed of plastic.

In additional examples, the apparatus is molded onto the connector body.

In additional examples, the liquid is configured to boil at the threshold trigger temperature.

In other examples, the liquid is configured to increase pressure on the sealed capsule upon reaching the threshold trigger temperature causing the sealed capsule to fail.

In additional implementations, wherein the sealed capsule is molded onto the electrical connector.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

The present disclosure will become more fully understood from the detailed description and the accompanying drawings, given purely by way of non-limiting example, wherein:

FIG. 1 is a functional block diagram of a vehicle having an engine compartment that incorporates an apparatus for early detection of thermal over exposure, the apparatus including a sealed capsule, such as a glass ampule containing a liquid with an ultraviolet (UV) dye shown incorporated on various exemplary electrical connectors according to principles of the present disclosure;

FIG. 2 is a front perspective view of the apparatus for early detection of thermal over exposure shown incorporated on an exemplary vehicle connector according to principles of the present disclosure;

FIG. 3 is a top view of the apparatus for early detection of thermal over exposure of FIG. 2 according to principles of the present disclosure;

FIG. 4 are exemplary sealed capsules each configured with a distinct liquid satisfying various trigger temperature thresholds according to principles of the present disclosure; and

FIG. 5 is a front perspective view of the apparatus for early detection of thermal over exposure of FIG. 2 shown subsequent to a thermal event that exceeds the trigger temperature and shown with the liquid and UV dye spilled out of the glass ampule and onto the connector body according to various examples of the present disclosure.

### DESCRIPTION

As previously discussed, as thermal damage on electrical connectors is difficult to see, it is often difficult to assess where exactly thermal damage has occurred. Electrical faults are inherently difficult to properly diagnose due to the complexity of the electrical systems and the number of wires on an automotive harness. The present disclosure provides an apparatus for early detection of thermal over exposure on vehicle components such as electrical connectors. The apparatus generally includes a sealed capsule, such as a glass ampule containing a liquid with an ultraviolet (UV) dye. In the event that the liquid exceeds a predetermined temperature, it expands causing the sealed capsule to break and spill the liquid over the connector body, and in some cases further around other nearby areas.

The UV dye is easily seen such as by shining a UV light. The UV light will illuminate the UV dye thereby identifying the area (such as a connector) that has experienced an over temperature thermal event. The apparatus can be chosen having a liquid that satisfies a desired temperature threshold. In other words, if it is determined that a thermal failure can occur on a particular connector that exceeds a threshold trigger temperature, an apparatus having a liquid consistent with expansion at the threshold trigger temperature is selected.

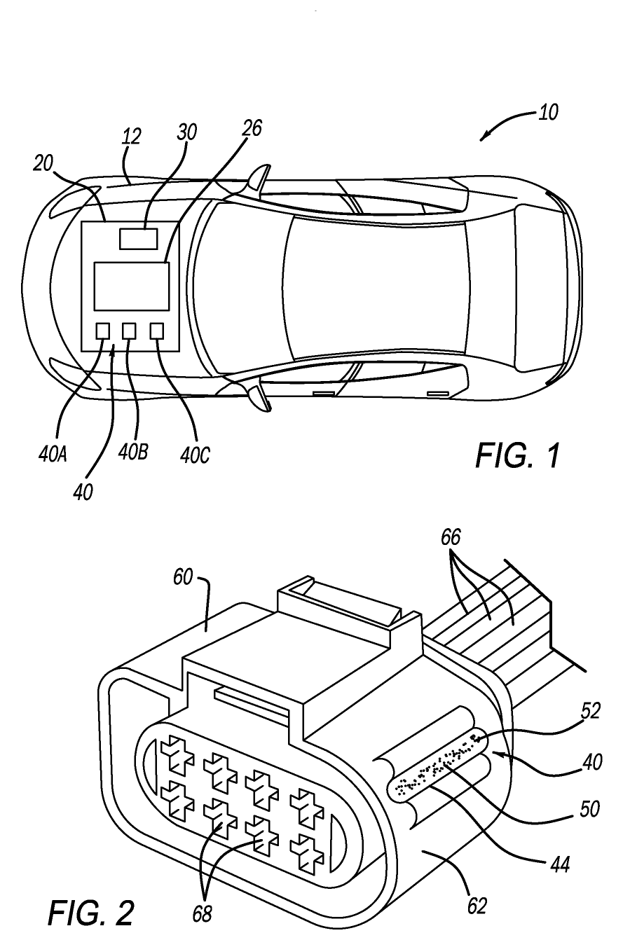

Accordingly, and with reference to FIG. 1, a functional block diagram of a vehicle 10 having an engine compartment 20 having an engine 26 and a battery 30 is shown. The vehicle 10 incorporates an apparatus 40 for early detection of thermal over exposure. The apparatus, collectively identified at 40, is shown incorporated at reference 40A, 40B and 40C. It will be appreciated that the apparatus 40 can be incorporated at many locations throughout the engine compartment 20, or the vehicle 10 as a whole, according to a specific application.

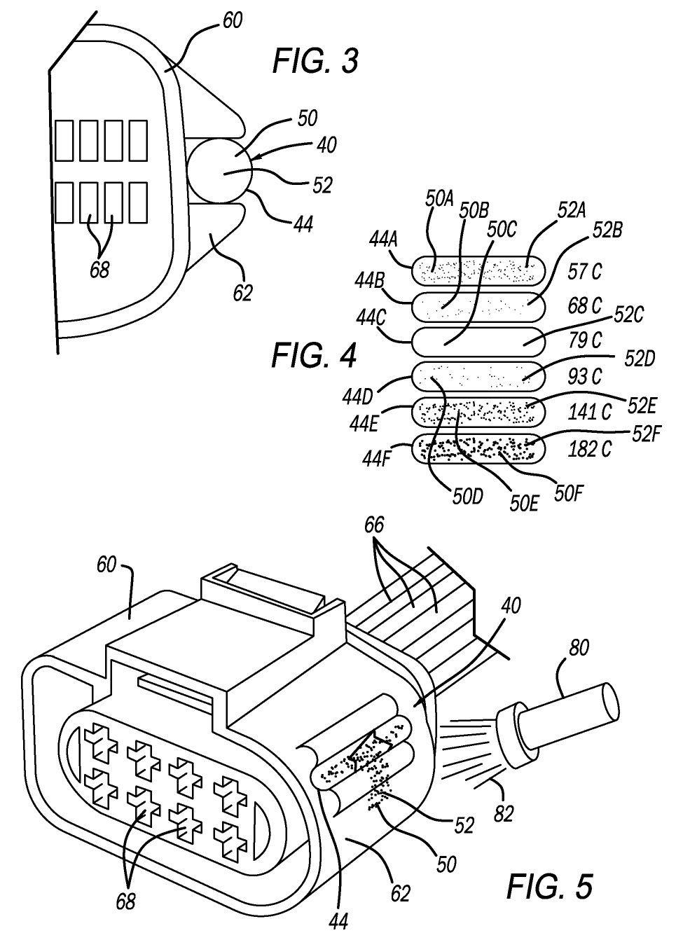

With continued reference to FIG. 1 and additional reference now to FIGS. 2-4, additional features of the apparatus 40 will be further described. The apparatus 40 generally includes a sealed capsule 44, such as a glass ampule containing a liquid 50 with an ultraviolet (UV) dye 52. The apparatus 40 is shown incorporated on an exemplary vehicle component such as an electrical connector 60. In examples, the apparatus 40 can be molded into the electrical connector 60. It is contemplated that some or all electrical connectors of the vehicle 10 can incorporate the apparatus 40. As described herein, the apparatus 40 can be configured with liquid having a desired thermal threshold temperature for any given application for identifying a variety of thermal incidents.

The electrical connector 60 can include a plastic connector body 62 that supports a collection of wires 66. The connector body 62 defines a corresponding plurality of electrical connector portions such as female receiving portions 68 configured to accept a complementary electrical connector (not shown). It will be appreciated that while the context of the following discussion is directed toward an apparatus 40 that is configured on an electrical connector 60, the apparatus 40 can be configured on a wide variety of other components on the vehicle 10 to facilitate identification of a thermal event.

The sealed capsule 44 can be formed of glass or other material configured to fail upon expansion of the liquid 50. FIG. 4 illustrates various sealed capsules 44A, 44B, 44C, 44D, 44E and 44F having different liquids 50A, 50B, 50C, 50D, 50E, and 50F. In examples, each liquid can have a corresponding dye 52A, 52B, 52C, 52D, 52E and 52F. Each liquid 50A-50F can have different thermal expansion properties. In the example shown, the liquid 50A can have a thermal expansion threshold of 57 degrees Celsius. The liquid 50B can have a thermal expansion threshold of 68 degrees Celsius. The liquid 50C can have a thermal expansion threshold of 79 degrees Celsius. The liquid 50D can have a thermal expansion threshold of 93 degrees Celsius. The liquid 50E can have a thermal expansion threshold of 141 degrees Celsius. The liquid 50F can have a thermal expansion threshold of 182 degrees Celsius. It will be appreciated that the threshold temperatures are merely exemplary and that other temperatures may be used.

With particular reference now to FIG. 5, an apparatus 40 is shown subsequent to a thermal event. In particular, the apparatus 40 has experienced a thermal event that exceeds the threshold trigger temperature of the corresponding liquid 50. In this regard, a thermal event occurred that caused the liquid 50 to expand (e.g., boil and/or otherwise reach a pressure that causes the glass 44 to fail). The liquid 50 and dye 52 is caused to spill over the connector body 62 of the electrical connector 60. As such, the dye 52 will leave evidence proximate to the component (electrical connector 60) that has experienced a thermal event that exceeds a predetermined temperature threshold.

An automotive technician can use a UV light 80 to shine UV light rays around the engine compartment 20 to identify any UV dye 52 (such as by wearing UV glasses). It is contemplated that various UV dye colors can be used to identify a range of temperature thresholds (see FIG. 4 discussion). Now, instead of having difficulty identifying the source of a potential failure from a multitude of components, the UV dye 52 can be located and the source component can be physically identified and further investigated.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

The terminology used herein is for the purpose of describing particular example embodiments only and is not intended to be limiting. As used herein, the singular forms "a," "an," and "the" may be intended to include the plural forms as well, unless the context clearly indicates otherwise. The term "and/or" includes any and all combinations of one or more of the associated listed items. The terms "comprises," "comprising," "including," and "having," are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as "first," "second," and other numerical terms when used herein do not imply a sequence or order unless clearly indicated by the context. Thus, a first element, component, region, layer or section discussed below could be termed a second element, component, region, layer or section without departing from the teachings of the example embodiments.

What is claimed is:

1. An apparatus for early detection of thermal over exposure on a vehicle component, the apparatus comprising:
a sealed capsule;
a liquid contained in the sealed capsule, the liquid configured to expand upon reaching a threshold trigger temperature; and
an ultraviolet (UV) dye disposed in the liquid;
wherein the liquid is configured to break the sealed capsule upon reaching the threshold trigger temperature, the liquid and UV dye thereby spilling onto the vehicle component allowing subsequent identification using a UV light.

2. The apparatus of claim 1, wherein the sealed capsule comprises glass.

3. The apparatus of claim 2, wherein the sealed capsule comprises an ampule.

4. The apparatus of claim 1, wherein the vehicle component comprises an electrical connector.

5. The apparatus of claim 4, wherein the electrical connector comprises a connector body having a plurality of electrical connector portions.

6. The apparatus of claim 5, wherein the connector body is formed of plastic.

7. The apparatus of claim 5, wherein the apparatus is molded onto the connector body.

8. The apparatus of claim 1, wherein the liquid is configured to boil at the threshold trigger temperature.

9. The apparatus of claim 1, wherein the liquid is configured to increase pressure on the sealed capsule upon reaching the threshold trigger temperature causing the sealed capsule to fail.

10. An apparatus for early detection of thermal over exposure on a vehicle component, the apparatus comprising:
an electrical connector;
a sealed capsule disposed on the electrical connector;
a liquid contained in the sealed capsule, the liquid configured to expand upon reaching a threshold trigger temperature; and
an ultraviolet (UV) dye disposed in the liquid;
wherein the liquid is configured to break the sealed capsule upon reaching the threshold trigger temperature, the liquid and UV dye thereby spilling onto the electrical connector allowing subsequent identification using a UV light.

11. The apparatus of claim 10, wherein the sealed capsule comprises glass.

12. The apparatus of claim 11, wherein the sealed capsule comprises an ampule.

13. The apparatus of claim 10, wherein the electrical connector comprises a connector body having a plurality of electrical connector portions.

14. The apparatus of claim 13, wherein the connector body is formed of plastic.

15. The apparatus of claim 10, wherein the liquid is configured to boil at the threshold trigger temperature.

16. The apparatus of claim 10, wherein the liquid is configured to increase pressure on the sealed capsule upon reaching the threshold trigger temperature causing the sealed capsule to fail.

17. The apparatus of claim 10, wherein the sealed capsule is molded onto the electrical connector.
